(19) United States
(12) Patent Application Publication
(10) Pub. No.: US 2017/0287354 A1
(43) Pub. Date: Oct. 5, 2017

(54) Mental Strengthening & Programming Systems & Methods

(71) Applicant: Mark S. Miller, Vallejo, CA (US)

(72) Inventor: Mark S. Miller, Vallejo, CA (US)

(21) Appl. No.: 15/084,092

(22) Filed: Mar. 29, 2016

(51) Int. Cl. G09B 19/00

(52) U.S. Cl. CPC G09B 19/0053

(57) ABSTRACT

The invention is comprised of systems and methods produced in modules to accelerate learning, creating & increasing ability and programming habits. The modules in order the user experiences are the module that teaches the predictable cycles of human consciousness and life to educate the User to understand what to do to improve their life and how to use the technology as effectively as possible to create maximum acceleration of increase of ability and programming of desired habits; a module that leads them to analyze themselves to determine what habits of ability and belief they will choose to improve; another module teaches and trains and then presents the techniques of mindfulness to accelerate the user developing the habit of identifying and releasing from the habit of ignoring life and neglecting their abilities to embrace nurturing their abilities to create functional habits of fulfilling their desires and needs to enjoy a life of their choosing, then there are three sets of three modules on the three modalities of thought, Symbols, Imagination & emotion and language, the first module educates and trains them to understand and execute each modality with effective skill, the second module is a library of Sets of content organized to program habit and create ability, the last module is a practice module that presents the content for the user to emulate and imitate causing the user to generate and control levels of energy beyond their ability without the presence of the content to guide their thoughts & emotion flow, this module will be adapted to accept content of any discipline of knowledge to enable the user to accelerate learning, then there is a module that operates in a mobile devise to trigger the User to continue generating and controlling the thoughts and emotions they desire to turn into new or improved ability or a new habit; last is the module that guides the user to plan, schedule and monitor their practice or programming sessions and other areas of their life to sustain consistent accelerated growth of ability and programming and refining of habits.

### BACKGROUND OF INVENTION

The present invention relates to mental improvement systems and methods.

The human race is evolving. Our brains ability to acquire knowledge and develop skill to master the elements of life is the driving force of our evolution. In our current state of evolution a significant percentage of people around the world, in every social class, lack the mental ability and thus still struggle at adapting to life. This primitive state of struggle exists because people are deprived of participating in a learning environment, for enough time, for the field of their conscious energy to stabilize and increase in power, enough, to acquire the accurate relevant knowledge and develop the necessary skills to be able to adapt to life rather than struggle. Even in the wealthiest homes children are ignored, neglected and even abused depriving them of participating in the learning process, for enough time, to nurture the mental ability to adapt. Generations of parents who were ignored, neglected and sometimes abused pass on the primitive ways to their children who grow into adults who because of their ignorance, exhibit the primitive states of resentment & rebellion, anger & hate, mental illness & disease, obesity & drug abuse, verbal & physical abuse, violence & wars which make up the social realities of our world today.

Imagine a world economy that is super charged with brilliant, creative & productive people all contributing to society with the passion of a playful child. Imagine a health industry that strengthens the strong rather than sedates the sick. Technology is the vehicle to improve the quality of life; the ultimate improvement will be liberating us from the primitive mental condition of foolishly ignoring relevant aspects of life that weakens our mental ability. It will be a blessed day when everyone has a strong grasp of the sciences, beginning with Physics, Psychology, Biology to simply understand how to avoid pain and suffering and create pleasure & fulfillment. The sciences taught effectively to humanity will inspire billions of people to join the scientific community increasing its size and productivity exponentially, thus accelerating improving our world exponentially. One area of research will be creating food supplements that allow us to generate significantly higher levels of energy with greater control inside the human body without compromising our health. From living in caves carving rocks into the tools & weapons to survive to the technology of today the next best place to direct technology is to strengthening & programming the brain & body of people to be stronger, smarter & wiser. A world full of effectively educated people free of fear of loss and full of passion to learn and grow is a goal we can achieve, and technology will be tool to do it. A system that significantly reduces the time a person needs to learn and develop mental ability is a tool that will accelerate us realizing this universally beneficial reality.

### SUMMARY

The preferred embodiment of the invention uses technology to accelerate learning, creating & increasing ability and programming desired habits in people faster than we ever have to this point in our history. It does this by synergizing Elements together that cause a user to generate and control levels of energy beyond their ability without the presence of the Elements. The increased presence of energy moving about in repeated patterns in the nervous system is what causes the accelerated learning, creation of & improvement of ability and programming of habits.

The central Element of the preferred embodiment of the invention is a module that presents the Content of thought & emotion in either a group of still photographs or moving video, i.e. computer generated images for the User to emulate and imitate allowing them to instantly generate & sustain more detail of the content. This liberates the User from the need to create the content; they only need to imitate it. This Element alone causes any user to generate and control levels of energy beyond their current ability. Continued emulation & imitation of any specific content will generate the connective tissue in the brain to allow the User to expand the content creatively; this is the skill of creative imagination which is a tool of intelligence. This is the skill Einstein used to discover his revolutionary discoveries.

To facilitate the User emulating & imitating the content with more ability the following modules presenting supporting elements are included. A module that uses computer generated images to illustrate the predictable cycles of human consciousness and life to educate a user to understand the invisible world of thought & emotion that lead to the habits of life functions to facilitate their emulating & imitating the content to expand it sooner; a module that educated and trains the user in Mindfulness to increase sensory acuity and thus control of thought; three modules that trains the user in the three skills of generating and controlling the three modalities of thought; three modules containing Libraries of content of thought & emotion on each of the modalities; a mobile devise that triggers the user to continue generating the controlling the thoughts they wish to habituate into higher abilities; a module for planning, scheduling and monitoring to maximize their use of the preferred embodiment of the invention to produce long term growth of improving ability and habit.

Advantages of the preferred embodiments may include one or more of the following. The system will accelerate our evolution by bringing an affordable product to the market that enables people to increase their abilities faster than we ever have in our history. The system uses existing computer technology to synergize multiple elements into a sensory experience that nurtures & intensifies the user generating increased levels of conscious energy & positive emotion that are not possible without the aid of the system. The increased flow of energy in the nervous system of the user causes accelerated growth of connective tissue in the brain which is the muscles of mental ability and the circuitry of habit & belief.

The evolution of the system will develop an extensive library of information about the energy of habits of ability & belief that create the life experiences of people that determine the quality of their life. This library of information will ultimately quantify the amount of energy & its precise movement necessary for all human ability & emotion. The “Charts of ability” will give each user an exact target to strive for to realize abilities that in the past were reserved for the people with gifted genetics and blessed lives grounded in the discipline that allows them to develop them. The charts of ability will be connected to growth charts which will allow the user to predict, based upon their practice time, when they will realize that ability. The practice or programming sessions will logically involve positive emotion or appreciation of the practice being done and the benefits from it.

The positive emotions generated and experienced by the user will make this new product a desirable choice in the market place, which, as a form of recreation, will actually cause the user to strengthen their nervous system to re-create themselves in positive ways that accesses more of the potential of their nervous system to create the things they desire in their life. When this product becomes as commonly used as shoes it will accelerate the evolution of us, the human race.

The accelerated strengthened nervous system will quickly liberate the user from the pain & suffering brought on from the weakened state of ignorance, experienced by everyone who has not created the habits of processing the relevant cause & effect realities of life that cause a person to get on the simple path to health & happiness. The simple path is light up from developing the beneficial habit of observing life to adapt to it rather than ignoring life to struggle in it. The first element to accelerate this increase in ability is an education in the sciences to accurately identify how to fulfill the needs and desires of being a social & biological living organism living in a socioeconomic world.

When this technology is used by generations of people the increased density of connective tissue will be increasing from generation to generate evolving significantly higher levels of ability to generate & control energy than is possible today. Theoretically, the increased levels of energy will eventually evolve the ability to manipulate matter outside of the human body with focused thought. The mathematical calculations, which I do not possess, to support this theory would calculate the increased power of the field of conscious energy reaching a critical mass of vibration or a new type of vibration to enable us to move about and interact with time & space in accordance with Quantum Physics rather than Classical. Potentially our brain will access the energy from all the cells of the body or we will create a biological metabolic machine our conscious can access the power from to generate & control the new type of vibration from the field of conscious energy. When we do this the universe will become a much smaller and interesting place. Mind you evolving to this level of being or ability could be as far from where we are now from our earlier state as a single cell life form; hopefully we're just a Neanderthal away. If this superior level of being and ability is possible technology will accelerate us realizing it.

The elements that cause the system to accelerate increasing ability & programming habit are:

1. Education & Training—To prepare the user to fully engage the system they are educated on the predictable cycles of human consciousness and life to inform the user why & how to engage the system as effectively as possible.

2. Engaging “the process” of identifying & releasing from the habit of ignoring life and neglecting their abilities to develop the habit of observing life to nurture their abilities.

3. A library of computer generated images of “human abilities” illustrating the details of high performance thought & emotion for people to load into the practice module to emulate, imitate & expand.

4. A “super charged learning habitat of synergized elements” that cause the user to generate & control levels of (Intensity & Clarity of Thought & Emotion 4 More Time) that are not possible without the presence of the elements. This creates the first half of the increased energy flow that maximizes acceleration of increase of ability & programming of habit & belief.

5. A mobile device to trigger & remind the user to practice imagining and or feeling a “formulated story of the desired content of life experience” throughout the day that constructs the desired habits of ability & belief in the nervous system exponentially increasing practice time. This creates the second half of creating the increased energy flow that maximizes acceleration of increase of ability and programming desired habits.

6. A Planning, Monitoring & Scheduling module that guides the user to fully engage & balance all of the elements of the system to optimize accelerating their growth of ability & programming of desired habits & beliefs.

Prior to feedback from the system in use an example of organizing the 6 elements and a brief summation of them is:

1) The genesis of humanity using technology to accelerate realizing the higher levels of conscious ability is the activity of acquiring an education on the purpose & potential of the field of conscious energy. Computer generated imagery will make this world of thought & emotion, ignored & invisible to most, visible and clearly definable to the user. Synergizing Physics, Psychology & Biology into a single perspective is necessary for the user to understand how their consciousness, their biology generating it and the environments they live in move about in predictable patterns. Understanding the patterns or cycles of life is one of the keys to realizing higher levels of ability to master life, and to becoming proficient in using this new technology to do it faster.

2) The next activity to accelerate increasing conscious ability is the first of many rounds of “the process” of analyzing the thoughts & emotions of their life. Mastering the thoughts, emotions & behaviors of life is the way to realize one's highest levels of ability. This technology will lead the user develop the habit of meticulously analyzing each and every habit of thought, emotion & behavior to refine it into its most effective form possible. Applying scientific knowledge to understand the processes of fulfilling need and desire will empower the user to see why they are either adapting to life effectively or struggling in it. This perspective gives the user the ability to predict their future based on the choices they make today.

3) The next activity to accelerate increasing conscious ability is for the user to use computer generated imagery to see how to precisely perform the mental techniques of Mindfulness, observing & identifying the thoughts & emotions of life as the phenomena that it is, which is distinctly separate from the self it is surrounding and impacting. Using the programming module to practice these techniques will cause the user to generate (Intensity & Clarity of Thought & Emotion 4 Enough Time) to program them into habit accelerating the emergence & strengthening of mindfulness, the light of conscious awareness that liberates a person from ignorant struggle. The increasing awareness of the field of conscious energy is the essence of the critical mass of sensory acuity to be able to embrace the technology that accelerates generating increased levels of energy with greater control.

4) The next activity to accelerate increasing conscious ability is to be educated in first of the three “Modes of Conscious Ability.” Symbolizing desired states of consciousness clears, enlarges & unites the field of conscious energy into a state of high performance poising the user to more effectively execute the other modes. The training in each mode forms the content of the element of Technique tips synergized into the practice module that accelerates the user developing sound fundamentals of high performance conscious ability free from any hindering factor. Computer generated images play a key role in illustrating the details of content of the conscious field of energy and what the biology does in generating the most energy possible with the greatest control. Detailed instructions on how to think more powerfully and effectively has been around for millennia; computer generated imagery illustrating everything a person needs to do to execute thought & emotion at high performance levels is what this system will do. Ahh, the best thing technology will ever do for humanity is to empower us with much more mental ability freeing us from the grips of ignorance opening the door to evolving higher abilities not yet realized.

5) To accelerate increasing conscious ability after each round of training and when discoveries are found or are being found regularly after practice sessions as well the user will engage another round of analysis of their habits of ability & belief to increase self knowledge including determining what percentage of potential ability they are accessing. Finding the balance of “Intensity of Effort with Relaxation of Skill” is fundamental to all mental ability as is choosing to consume the nutritional needs of the biology that generates and controls energy. To realize highest levels of ability the user will need to search, discover and program away limiting beliefs, dysfunctional desires or habits that reduce the health of their biology and the quality of conscious experiences of their life.

6) The next activity to accelerate increasing conscious ability is for the user to access the library of Symbols of high performance conscious states to load into the practice module. The Symbols will be organized into fundamental, low, intermediate, high and antidotal to common dysfunctional habits of thought.

7) The next activity to accelerate increasing conscious ability is to practice emulating the Symbols to generate the macro state of conscious energy under more relaxed control that is expecting positive results.

8) The next activity to accelerate increasing conscious ability is the training in the second mode of conscious ability—Imagination & Positive Emotion, Imagination, the tool to reproduce cause & effect reality of life to think “the thought experiments” to acquire & verify the knowledge of life, and Emotions added to Imagination programs the nervous system with desired habits and heals cells damaged from stress & toxicity with positive energy.

9) Then another round of self analysis to increase sensory acuity and discover any limiting beliefs or aspects of their consciousness that is reducing their realizing more ability.

10) Then the user accesses the library of “sets of images” that represent the outcomes they desire in their life empowered with positive emotions and the arduous activities empowered with appreciation of its benefit. These sets of images will effectively address internal states of being that causes the person to create the desired external reality. In the future these sets of images will fill extensive digital libraries.

11) Then to accelerate increasing conscious ability the user engages the practice module to imitate the content of the sets of images to the best of their ability. As their ability allows they also emulate the macro state at the same time.

12) The next activity is the training in the final mode of conscious ability of Language, the tool to communicate with others & itself to direct the Symbols and to direct & interact with Imagination & Emotion.

13) Then another round of self analysis to increase sensory acuity and discover any limiting beliefs or aspects of their consciousness that is reducing their realizing more ability.

14) Then the user accesses the library of “sets of language” that support and interact with the sets of images. These sets of language in the future will also fill extensive digital libraries.

15) Then to accelerate increasing conscious ability the user engages the practice module that synergizes the language with the images with the techniques tips. Effectively engaging the elements of the practice module causes the user to generate (Intensity & Clarity of Thought & Emotion 4 Enough Time) to cause the content to repeat in the thoughts & emotions for hours after each session.

16) Then to dramatically accelerate increasing conscious ability the user has their mobile devise trigger and remind themselves to continue to flow the desired content throughout their day increasing their practice time exponentially.

17) The final element to accelerate increasing ability is for the user to engage the monitor, plan & schedule module to optimize the practice, play, work and rest to the best of their ability accelerating increasing their ability and presence of healthy habits to improve the quality of their life.

The technology will deliver desired results to the user with a formula that calculates the details of the content of the energy of the thought & emotion necessary to create a new habit, belief or ability. The formula is:

(X Intensity&X Clarity)of(X Thought&X Emotion)for(X More Time)or I&C of T&E4MT

This formula will be used to create Charts of Ability, Growth Charts for users to use in the self improvement efforts using the system.

This system will create a sister industry of health care professionals and high performance coaches, councilors creating formulas to load into the Practice Module enable people to accelerate overcoming any negative reality that healthy habits, empowered beliefs and increased abilities will antidote. Weight loss, improved personal relationships at home and work, improved skills at work or school, healing psychosomatically caused diseases, enjoying life, saving money, etc.

### BRIEF DESCRIPTION OF THE DRAWINGS

FIGS. 1-9 show exemplary processes in the system to accelerate increasing human ability to generate more energy with greater control, and

FIG. 10 shows an exemplary system to accelerate increasing human ability to generate more energy with greater control.

### DESCRIPTION

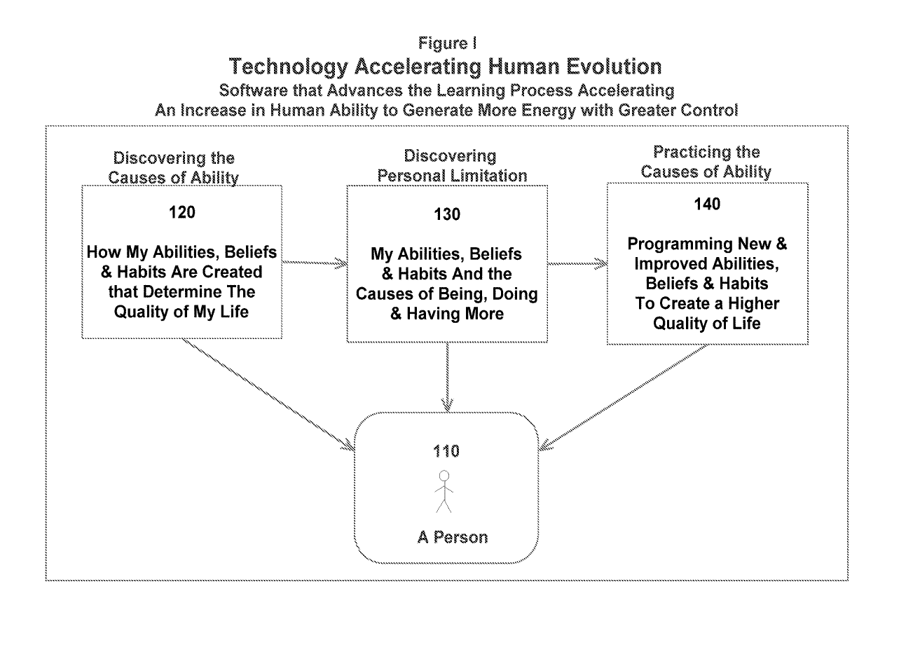

FIG. 1 shows how the preferred embodiment of the invention will accelerate increasing human ability to generate more energy with greater control. Generating & controlling energy is the quintessential cause ability of all forms of life. Technology is increasing our ability to generate & control more energy primarily outside of the human body; inside the human body is the most beneficial, exciting and thus relevant place to Increase this ability. The preferred embodiment of the invention systematically produces “the Elements” that nurture & intensify the learning process facilitating the User generating & controlling the energy of thought & emotion at increasing levels. The increasing levels of energy causes accelerated growth of the connective tissue in the brain that is the power source ability & the circuitry of belief & habit. Engaging the preferred embodiment of the invention causes a User to experience positive emotion making continued use a natural choice.

The evolution of the preferred embodiment of the invention in the coming years and decades will create vast libraries of data on the energy flow and control of all human ability from conscious awareness to the most complex mental or physical activity any person is capable of, ala riding on a beam of light. Fundamental in all of the data the formula below to will provide all users with definite amounts of energy they must generate and control to create any new & improved ability, belief & habit.

(X Intensity+X Clarity)of(X Thought+X Emotion)for(X Time)or(I&C of T&E4MT)

Manufacturers of this product, High Performance Coaches & Health Care Professionals will use the formula to supply Users with Programming or Practice Sessions to create new or improved abilities, beliefs & habits for improved performance and liberation from primitive states of pain & struggle.

In 120, the user is shown how the principles of Physics enable them to see & understand the Cause & Effect interdependent relationship between Psychology & Biology interacting to create the thoughts, feelings of habits of ability & belief that make up the experiences of life; these most relevant truths about how the abilities, beliefs & habits are created and function determine their Health & Happiness. This information shows the User how this technology enables them to accelerate creating new & improved abilities that will liberate themselves from struggle & pain and significantly improve the quality of their life.

In 130, the User engages “the Process” of identifying their low abilities, limiting beliefs & dysfunctional habits to select desired content of thoughts & emotions to program ever higher levels of being, doing & having more into their nervous system.

In 140, the User engages the Elements that Nurture & Intensify the Learning Process Facilitating Increased Levels of Energy Accelerating Memorizing & Mastering Information, Developing & Refining Mental & Physical Skill, Applying Increased Doses of Therapy to Heal Psychosomatically Caused Diseases & more. As Generations use this Technology we, the Human Race will Realize New Abilities not yet Evolved.

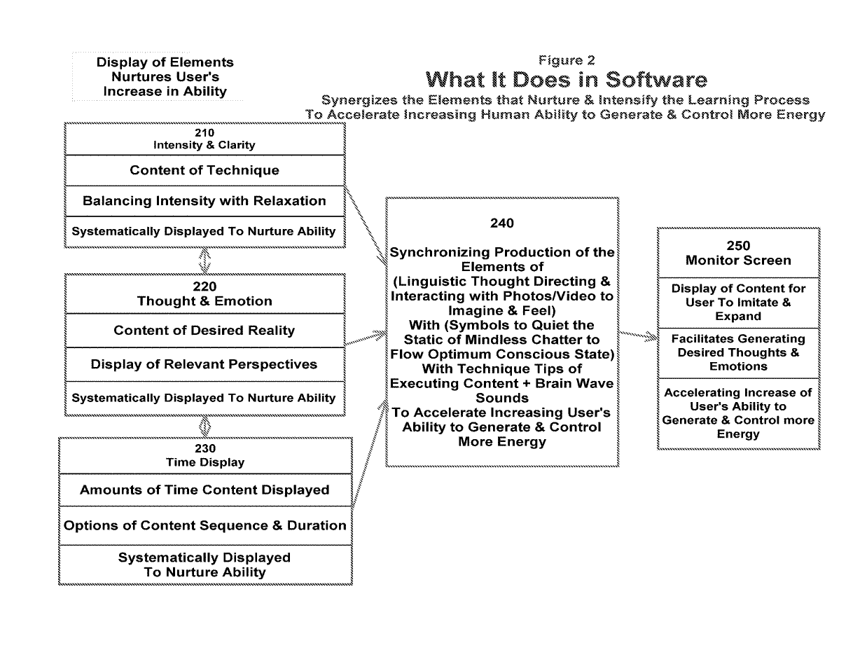

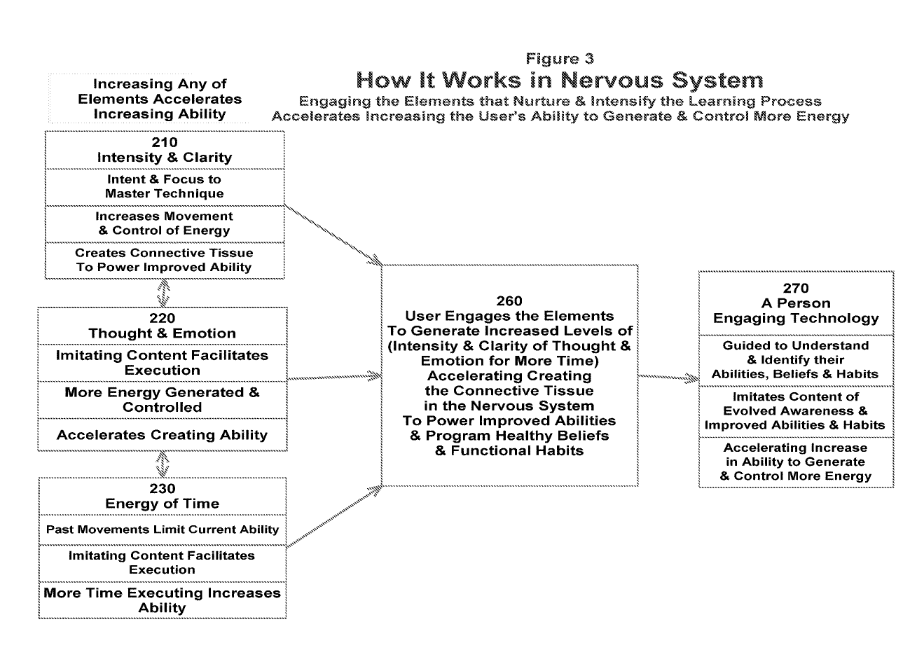

FIGS. 2 AND 3 shows the software synergizing the elements that nurture & intensify the learning process to cause the User to immediately generate and control levels of energy beyond their current ability causing an acceleration of increase of ability and programming of new habits & beliefs in the User.

210 shows how the training and then display of techniques increases the user's intensity and clarity in executing the content being practiced or programmed, and in 220 the display of the content of thought and emotion frees the user from needing to create the content, they only need to emulate & imitate it causing an immediate increase in the details and thus presence of energy being generated and controlled. When the user completes generating and controlling a critical mass of emulating and imitating the content they will be poised to expand it creatively, the essence of creative intelligence. 230 illustrates how time is energy and so the more time the user engages the elements of the preferred embodiment of the invention generating I&C of T&E 4 MT the faster their growth of ability or programming of habit is imprinted in the nervous system and thus realized. 240 lists the basic elements synchronized in the software to be produced in 250 to advance the learning process into a programming process that increases the user generating and controlling energy represented in 260 & 270. The steps of executing the elements produced by the preferred embodiment of the invention that cause the user to generate I&C of T&E 4 MT to accelerate increasing ability & programming habits represented on Diagrams 3 & 4 are:
One—The prototype will teach the core principles of Physics, Psychology & Biology to illustrate how abilities, beliefs & habits that determine quality of life for people are created & function. These principles form the basis for understanding high performance, health, & happiness and a vocabulary to use the technology
Two—The User is lead to apply these principles to their own abilities, beliefs & habits to stop identifying with them but rather see them as phenomena that can be changed with Practice or Programming. This information is composed to inspire the User with a desire to realize their Full Potential to improve their life & thus Improve Our World. This technology accelerates this precious process.
Three—A Library of Symbols that cause the User to emulate high performance consciousness are available to select, modify & load into Practice Module to program their nervous system
Four—A Library of Images & Emotions, representing desired realities of Being, Doing & Having more are available for the User to select, modify & load into Practice Module to program their nervous system
Five—A Library of positive beliefs and self talk that antidote the causes of low ability & struggle are available for User to select, modify & load into Practice Modules to program nervous system
Six—Practice Module produces a variety of synchronized displays of Content(s) of Symbols, Images & Emotions and Language with Technique tips, brain wave sounds or inspiring music to nurture & intensify the User generating increasing levels of I&C of T&E 4 MT reducing the time required to strengthen & program their nervous system.
Seven—Mobile Devise produces sounds & display of Content thru-out day triggering & reminding the User to A) Continue engaging the high performance consciousness to flow the improving beliefs, habits & abilities further accelerating growth. B) Observe, identify & record weak links in their abilities to adjust their focus in Practice C) Monitoring their progress to assure growth D) Appreciate it all to realize Personal Fulfillment in their Life.
Eight—Planning, Scheduling & Monitoring Module guides the User to use their Imagination to methodically apply Physics to the Cycles of Growth of the Psychology & Biology of their improving abilities, beliefs & habits. This prototype of the invention will guide the User to think scientifically & creatively increasing the chances of realizing their highest abilities.

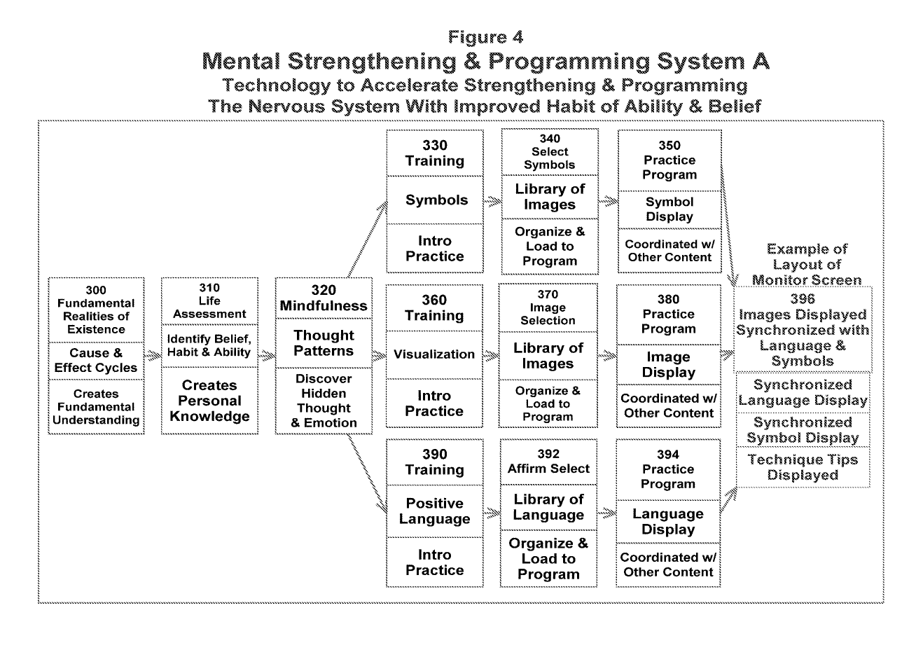

FIG. 4 shows the first half of the modules that accelerate strengthening & programming the nervous system with improved habits of ability & belief. In 300, the user view the computer generated images illustrating the cycles of life to distinguish between mindfully attending to thought & emotion to nurture ability to effectively adapt to life verse mindlessly ignoring & neglecting ability and thus struggle at life. In 310, the user is then lead to identify their habits of abilities & beliefs that has been determining the quality of their life; this process the user will continuously engage in using this product. In 320, the preferred embodiment of the invention continues to use computer generated imagery to introduce the Mindfulness techniques of identifying & nurturing thought & emotion that is required to effectively adapt to life in an aware state. This module has the user engage the introductory material of modules 440, 450 & 460 to have their nervous system experience these fundamental techniques that increases sensory acuity to thought & emotion. This is “the one process” that people use to liberate themselves from mindless struggle by engaging the precious process of nurturing the ability to adapt to life. In 330, the new product continues using computer generated imagery in the training on using Symbols to stabilize & expand the macro state of their conscious field into a high performance state that poises the User to execute the micro details with their highest abilities; this training becomes part of the Technique tips synergized into the Practice Module to accelerate the user developing sound fundamentals in executing this modality of thought. In 340, the user selects the computer generated images of the Symbols to load into Practice Module for Programming. In 350, the Practice Module generates the Content synergized in the Elements for the User to emulate causing an immediate increase in levels of I&C of T&E 4 MT to accelerate stabilizing & expanding their conscious field of energy from the accelerated generation of brain muscles of new connective tissue. This initial modality of thought is the foundation for the User to access more of their brain's resources of Psychology & Biology to realize their highest levels of ability. In 360, the user is trained in the second modality of Imagination & empowered with Positive Emotion to discover the brain's ability to use Creative Imagination as the tool of Intelligence, Health & Happiness, & Programming desired Realities; this training also becomes a part of the Technique tips synergized into the Practice Module to accelerate the user developing sound fundamentals in executing this modality of thought. In 370 the User selects the Content of sets of images of outcomes of desired realities empowered with positive emotion & the arduous activities of creating them empowered with appreciation they will load into Practice Module for programming. In 380, the Practice Module generates Content synergized into the Elements for the User to imitate causing an immediate increase in levels of I&C of T&E 4 MT of the Content to accelerate programming their nervous system with improved habits of ability & belief from the accelerated generation of new connective tissue. In 390, the process continues with training to use language to improve communication with self to stop mindless chatter distracting the stabilizing and expanding of the consciousness, to direct and interact with Imagination & Emotion that also increases their proficiency to use the product to program their nervous system with improved habits of ability & belief. In 392, the user selects & modifies positive Language to load into Practice Module to be synchronized with the other two modalities. In 394, the Practice Module generates the Content synergized into the Elements for the User to emulate, imitate and eventually playfully expand causing the increasing levels of I&C of T&E 4 MT of Linguistic Thought Directing & Interacting with Images & Emotions that accelerates generating the connective tissue in the nervous system to power improved abilities and create improved habits & beliefs about the world and how the self fits into it. 396 represents the display monitor & Speakers that produces the Content for User to emulate, imitate to in time playfully expand practicing and programming the desired realities they are creating in their life.

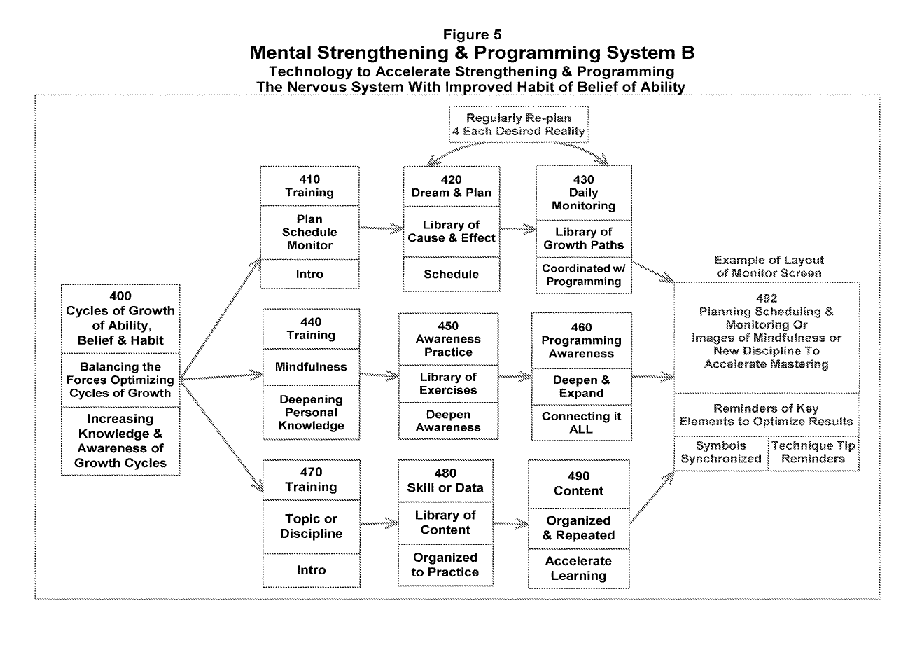

FIG. 5 shows the second half of the modules that accelerate strengthening & programming the nervous system with improved habits of ability & belief. In 400, the user is methodically guided with computer generated images to see & understand the internal & external forces at work in cycles of growth of ability. This knowledge enlightens the User to balance the forces of growth in their life to accelerate being liberated from struggle & realizing more of their potential abilities. In 410 the User is trained to apply what they've learned to fully engage the Planning, Scheduling & Monitoring Module to optimize their growth. In 420, the user is lead to continue exploring & developing the details of the new realities they are creating inside of their Psychology & Biology to create the life they desire in the world. In 430, the user engages the elements to flow high performance consciousness that appreciates the life long process of balancing & aligning the resources of growth to realize their highest abilities to create the life they most desire full of abundance, which this prototype will teach the need to positively contribute to society to create a shining self esteem of a happy person that also contributes to the evolution of the human race. In 440, the process continues with continued training on Mindfulness's role to continue improving the energy flow of consciousness & emotion. This training, potentially in different models can extend into advance stages of consciousness of the best training from the best teachers on consciousness usually found in the spiritual teachings of historic figures or documents such as the Yoga Sutra. In 450, the user selects Content of techniques from the Library of Mindfulness to load into Practice Module to program accelerated awareness that can target current challenges or overall improved conscious awareness & ability. In 460, the Practice Module produces the Content synergized into the Elements for the User to emulate, imitate and playfully expand causing an immediate increase of I&C of T&E 4 MT that accelerates generating the connective tissues to strengthen & program their nervous system with improved habits of ability & belief. In 470, the new product can provide training for any discipline to accelerate learning & developing skill: Communicating, Parenting, Student & Career Skills, All Scholastic Studies, Sports Performance, Nutrition & Health, etc. 480 will be the Library of Content on the discipline being studied for the User to load into the Practice Module to program accelerated learning. In 490, the user engages the new technology to program the content into his/her nervous system. In 492, the monitor displays Content for User to engage to improve their Life Knowledge & Skills.

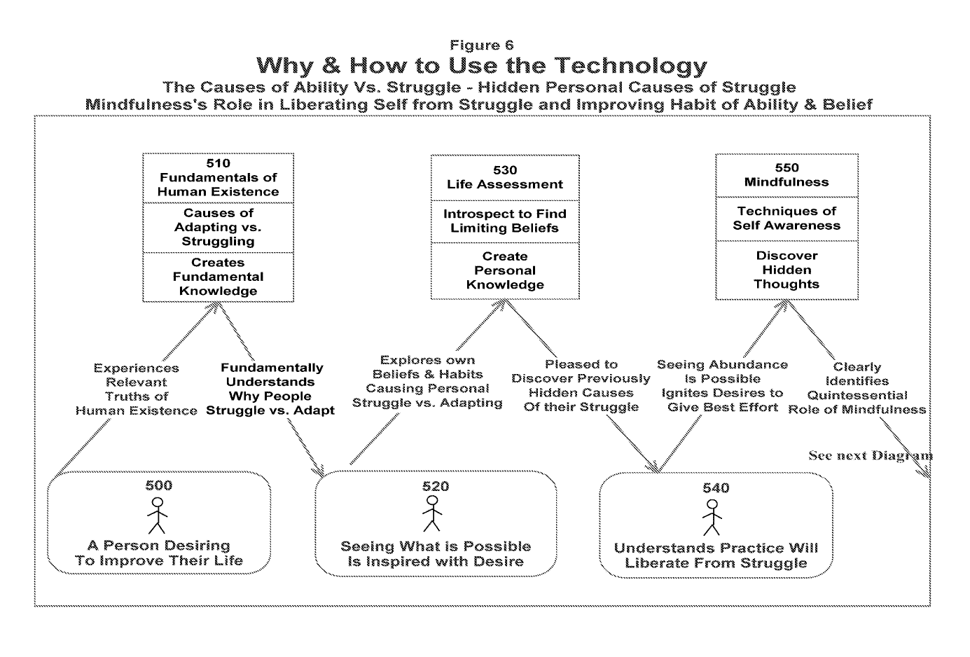

FIG. 6 shows the introductory modules of the preferred embodiment of the invention that A) Educates the user to understand the causes of acquiring and improving the ability to adapt vs. the causes of ignoring & neglecting the ability and thus struggling at life B) Discovering their hidden personal causes of struggle and C) Mindfulness's role in liberating them from struggle by nurturing their habits of ability & belief. In 500, a person engages 510 to learn the principles of the core sciences of Physics illustrating the interdependence of Psychology & Biology to make the key distinguish between mindfully nurturing their ability to generate & control energy that creates the habits of thought, emotion & behavior that enables them to effectively adapt to create a high quality of life vs. mindlessly ignoring & neglecting their abilities, beliefs & habits and thus struggle into a low quality of life. The computer generated images illustrating how generating & controlling energy is the quintessential cause of ability of all forms of life will give the user a clear and definite understanding of the premise to focus on when using the technology. More energy, controlled more for more time equals more results. In 520, with an understanding of the need to strengthen & refine their habits of thought & emotion the user engages 530 to apply these self evident principles of the three core sciences to think scientifically about their own abilities, beliefs & habits rather than identify with them. This revelation of insight illuminates the opportunity to use the technology to generate I&C of T&E 4 MT to accelerate liberating themselves from the causes of their struggle to quickly realize more of their potential abilities to enjoy an improved life. In 540, the user then engages 550 to view the computer generated images illustrating Mindfulness's role functioning in a field of conscious energy to release from struggle to engage in the precious process of increasing ability to improve the quality of their life. Then the user imitates the thought patterns, illustrated with the computer generated images, of an effective field of conscious energy identifying & releasing from negative and mindless thoughts to nurture ability to adapt to life.

These introduction modules educate the user on the benefits of and how to fully embrace the elements that nurture and intensity them generating & controlling levels of energy that is beyond their current ability. This increased flow of energy will be for many a fountain of ability or youth. It accelerates the growth of connective tissue of the brain that is the source of increased ability as well as circuitry of habit & belief. Even a brief practice session causes the user to generate the critical mass of thought & emotion necessary to cause the content of thought & emotion or life experience to flow in their nervous system for hours after each session. Then the mobile devise triggers & reminds the user to continue generating and controlling the desired improve abilities or habits creating years of training or experiential therapy in a matter of months or even weeks. This is the essence of the preferred embodiment of the invention.

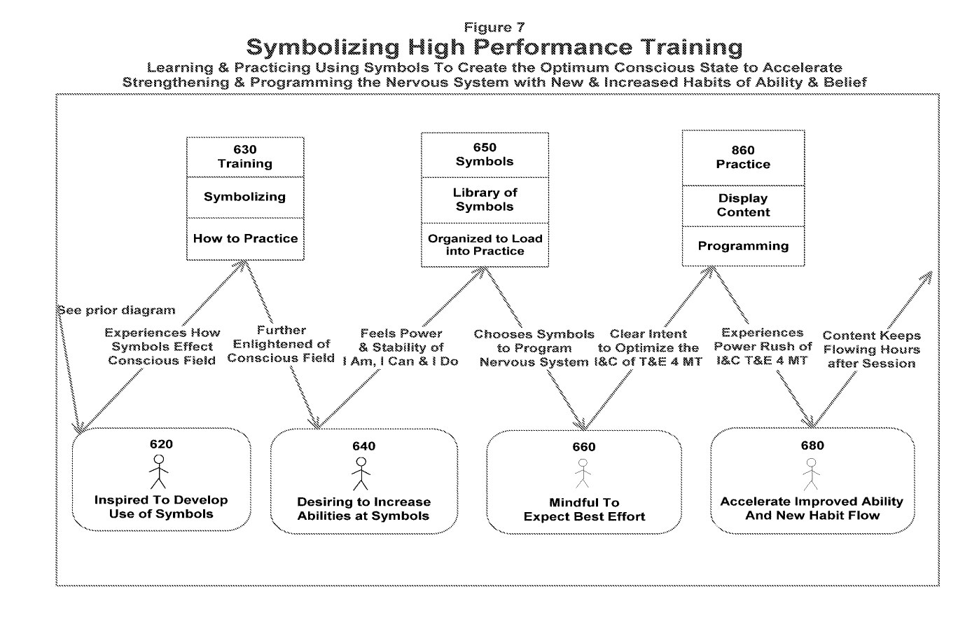

FIG. 7 shows how the teaching & training to use Symbols to create the macro state of high performance consciousness that possesses increased resources to execute the micro details of content at high performance levels. In 620, the user engages training of 630 to view computer generated images illustrating Symbols functioning in a field of conscious energy to acquire an advanced understanding on the subtle techniques of using Symbols to A) Stabilize & enlarge their field of conscious energy B) Restore a healthy desire to shine as bright as possible as a person C) To wisely be grounded in a purpose to do more and more of the things needed to create & enjoy the best life possible for them D) Quiet the negative & mindless thoughts that distract & destabilize the flow of positive & effective conscious energy E) Engage & unit the left & right lobes of the brain to participate in the thought processes of life increasing the mass/power of their consciousness F) Establish a clear & definite intent to always give their best effort with an attitude & expectation of being as effective as possible right now & in future. Trained on these techniques the user in 640 engages 650 to select & personalize a Set* of Symbols to load into Practice Module and the refined set into the Mobile Devise for playful practice pretending to already possess the characteristics of a high performance conscious state of flow. In 660, the User, mindful to expect their best effort, engages the Elements of 670 Practice Module to generate levels of (I&C of T&E 4 MT) beyond their current ability without the presence of the Elements. Increased sensory acuity to the inner world of thought & emotion from the education on human consciousness via the three core sciences plus Mindfulness training & programming increases the User's ability to fully embrace the Elements of A) Emulating the Content to cause an instant increase in energy generated B) The increased time emulating the content, at 1st for seconds eventually expanding to minutes, further increases the energy generated during each repetition of practice and thus the entire session as well C) Encouragement to give best effort to realize full potential adds further to the increase, D) Technique tips reminds the User be & do the fundamentals in the midst of their best effort further adding to the increase of control, D) Brain wave sounds to ground in Alpha or inspiring Music adding more to increase, E) Any additional Element found to nurture or intensify the User's practice of developing their conscious ability to their highest level.

The Elements of the technology causes a User to generate the critical mass of focused energy that is beyond their current ability causing the desired content of life experience to flow in their nervous system hours after each session. Then the mobile devise triggers & reminds the User to continue generating & directing this flow creating years of training & experiential therapy in a matter of months or even weeks. This is the essence of the preferred embodiment of the invention to create maximum accelerate of increase of ability and programming of new habit.

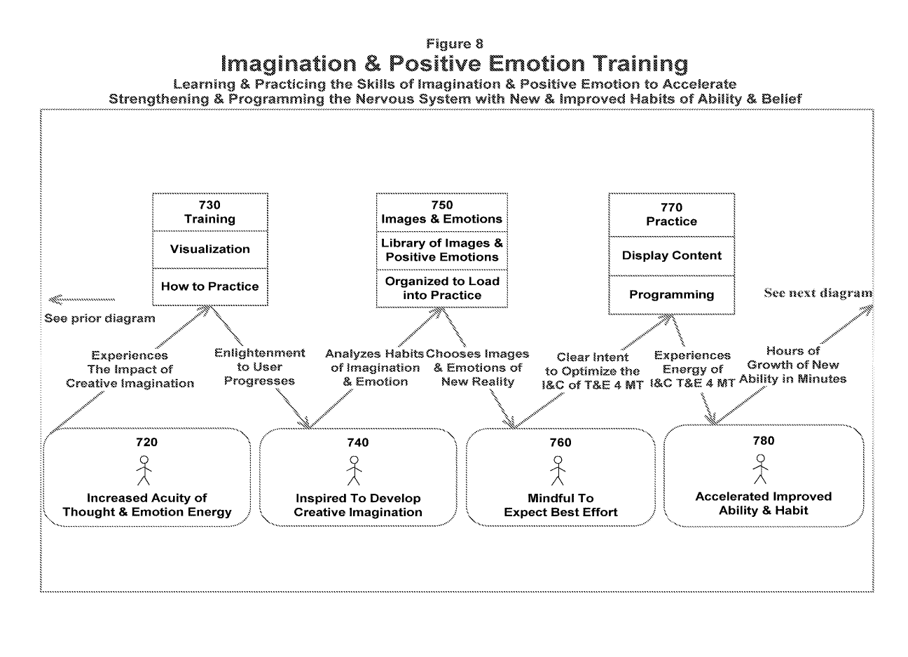

FIG. 8 shows the education & training in the Skills of Imagination & Positive Emotion will accelerate strengthening & programming the nervous system with new & improved habits of ability & belief. In 720, the User engages the training of 730 to view the computer generated images illustrating Imagination & Positive Emotion functioning in a field of Conscious Energy and flowing up and down the spinal cord. These illustrations accelerate the user acquiring an advanced understanding of the subtle techniques of creating sensory rich images empowered with positive emotion that accelerates their ability to become proficient in using the technology. Using the technology effectively allows the user to maximize their rediscovering & developing the abilities of the creative imagination, when appropriate, empowered with positive emotion. The quintessential skill of imagination enable the user to A) Complete the thought experiments required to acquire & use accurate knowledge that is relevant to their health & happiness, B) Program improved habits of abilities & beliefs, including the habit of flowing healthy positive emotions to heal damaged cells from chronic stress to create a life of abundant health & happiness. In 740, the User, inspired to develop the creative imagination engages Library of Images & Emotions of 750 to select & personalize Sets* of still & moving images that represent relevant perspectives of A) already being, doing & having the realities they desire empowered with positive emotion and B) the disciplined activities of creating them empowered with appreciating the strength of being that person.

The Charts of Ability & Growth,* not included in this patent, will establish A) a critical mass of perspectives and B) the time they are imagined, felt and experienced on any desired reality that will cause the User to create it. The Growth Chart will also supply the User with an earlier point in the growth cycle when increased momentum of developing improved habits of ability & belief is realized from the practice when the User is liberated from the distraction of illogical fear & doubt. The nervous system is like a room that can be cluttered with obstacles slowing the movement of a person or in this case energy of thought. When the doubt and fear hindering the free movement of thought is cleared away the potential movements are increased.

The Sets* of images & emotions selected from the library are loaded into Practice Module and the refined set into Mobile Devise. In 760, the User engages the Elements of 770 Practice Module to generate levels of (I&C of T&E 4 MT) of the content, that are increasing, that is beyond their current ability without the presence of the elements. Increased sensory acuity to the inner world of thought & emotion from the education on human consciousness via the three core sciences plus Mindfulness training & programming allowing the User to fully embrace A) Imitating the content causing a) increased sensory details of the content that increases the presence & control of energy b) sustaining the content for More Time, (at 1st for seconds eventually expanding to minutes) further increasing the energy generated & controlled B) Encouragement to give Best Effort adds further to the increase, C) Technique tips reminds the User be & do the fundamentals in the midst of their best effort further adds to the Increase, D) Brain wave sounds to ground in Alpha or inspiring Music adds more to increase, E) Any additional Element found that will nurture or intensify the User's practice of mastering the quintessential conscious ability of imagination is the spirit or essence of the preferred embodiment of the invention.

The Education & Elements of the preferred embodiment of the invention causes a User to generate the critical mass of focused energy that is beyond their current ability causing the desired content of life experience to flow in their nervous system hours after each session. Then the mobile devise triggers & reminds the User to continue generating & controlling this desired flow of Energy creating years of training or experiential therapy in a matter of months or even weeks.

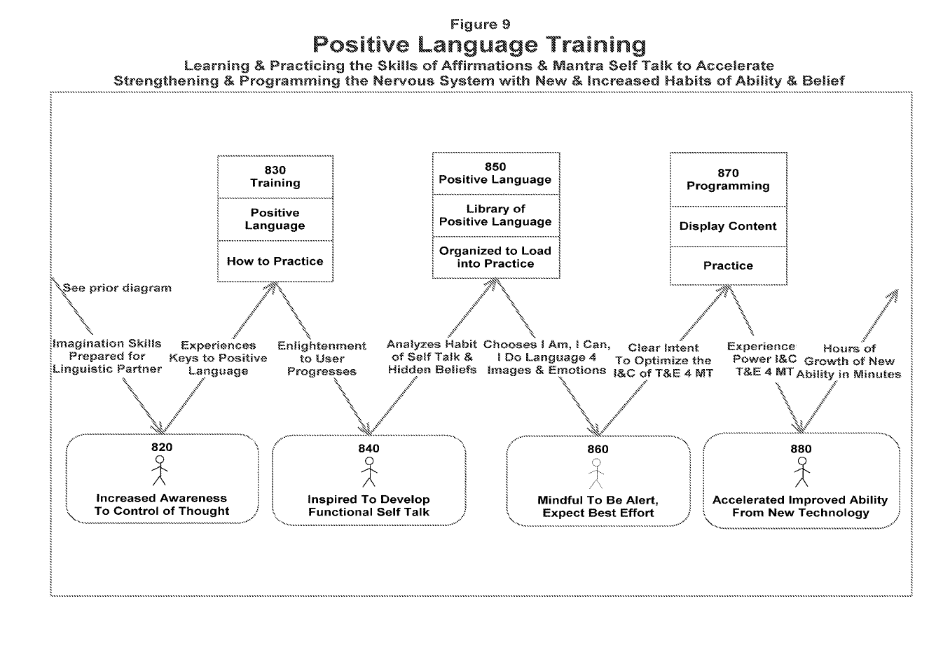

FIG. 9 shows the Positive Language training, where the learning & practicing the skills of affirmations & mantra self talk & self talk will accelerate strengthening & programming the nervous system with new & improved habits of ability & belief. In 820, the User engages the training of 830 to view the computer generated images illustrating Linguistic Thought functioning in a field of Conscious Energy to gain an advanced understanding in the techniques of composing & using Positive Affirmations, Mantras & Self Talk conversations. This advanced understanding accelerates them becoming proficient using the technology as well as using language in their life. Using language effectively enables the User to A) Generate & control more energy throughout their life B) Use the preferred embodiment of the invention to program themselves in almost any way they desire beginning with becoming more and more aware in their life to identify & release from negative & mindless self talk that distracts and reduces the attention, awareness and ability to complete the task required to fulfill need and desire C) Influence the people in their lives to be positive, pay attention & adapt so that less of the people in their life are struggling in pain. In 840, the User engages Library of Language of 850 to select & modify Sets* of Affirmations, self talk conversations & Mantras to direct & interact with the images & emotions selected in the Visualization Module to load into Practice Module and the refined set into Mobile Device, see Charts of Ability & Growth. In 860, the User engages the Elements of 870 the Practice Module to generate levels of (I&C of T&E 4 MT) of the Content beyond their current ability without the presence of the element. Increased sensory acuity to the inner world of thought & emotion from the education on human consciousness via the three core sciences plus Mindfulness training & programming increases the User's ability to fully embrace A) Emulating & imitating the three modes of content required to create a high performing field of conscious energy, (executing the macro state of conscious energy that assesses maximum resources available to execute the micro details of the relationship between the Language directing and interacting effectively & efficiently with the Images & Emotions) to cause the maximum increase in the generating & controlling energy from this Element in each instance, B) sustaining it for More Time, (at 1st for seconds expanding to minutes) further increasing the energy generated & controlled. B) Encouragement to give Best Effort to Realize Full Potential adds further to the increase, C) Technique tips reminds the User Be & Do the fundamentals in the midst of their Best Effort further adding to the Increase, D) Brain wave sounds to ground in Alpha or inspiring Music adds more to increase, E) Any additional Element found to Nurture or Intensify the User's practice of using Language to direct their Imagination & Emotions to be more Effectively Positive in their Life.

The Practice Module causes a User to generate the critical mass of focused energy that is beyond their current ability causing the desired content of thought & emotion to flow in their nervous system hours after each session. Then the mobile devise triggers & reminds the User to continue generating & directing this desired flow of energy creating years of training or experiential therapy in a matter of months or even weeks.

### Expanding Beyond the Diagrams

The ability of any person is determined by the amount of energy they generate and control in their nervous system, mental ability in the brain, physical ability in the torso and limbs. A person with an evolved intellect can process large amounts of information in the blink of an eye compared to a person without the developed muscles of connective tissue in the brain could labor to process the same information or possibly not be able to. As well high performance ability to compete in any endeavor requires an increased flow of energy moving about in the nervous system with skillful precision. This system uses technology to synergize multiple elements of education & training plus content of thought & emotion for the user to emulate, imitate & expand that cause the user to generate a critical mass of desired content of thought & emotion, beyond their current ability, causing the desired thoughts & emotions to flow in their nervous system for hours after each session. Then the mobile devise triggers & reminds the user to continue generating & controlling this desired flow of life experience throughout their day exponentially increasing the time they are thinking, feeling and being the person they desire to be. Increasing the amount of energy, the focus of it and the time it flows in the nervous system will, in my opinion create years of growth in months if not weeks. The continued exposure to the increased flow of energy in the nervous system causes accelerated growth of the connective tissue in the brain that powers improved ability to generate & control energy as well as habits of thought & emotion in their life.

Ability & habit are interdependent aspects of a human nervous system. When a person changes their habits they change the realities of who they are, what to do and thus what they create in their life.

A change in the habits of energy of thought & emotion about eating well and exercise rigorously will cause a person to lose weight and improve their health.

A change in habits of energy of stressful thoughts & emotions about the reality of ignoring needs & desires to relaxing fulfilling thoughts & emotions of attending to them will improve a person's life to the exact degree the need or desire is needed or desired plus how long it is neglected.

A change in habit of energy of interest in investing more time at improving ability at anything that relates to the role in society will improve the shine of their self esteem.

A change in habit of thinking about dealing with a difficult person with assertive kindness will change the way the difficult person interacts with him or her.

A change in habits in the amount of positive thoughts & passionate feelings about taking on the responsibility of caring for every important need is a quality life changing choice.

A change in habit into choosing to balance dysfunctional desires with functional ones will cause the person to increase the vitality of their health & level of happiness to move toward living the best life possible for them.

The spirit of this system is to synergize the most powerful elements in the proper order, in precise proportion & duration to create the most powerfully effective acceleration of increase in ability possible; refining this process will be work of future manufacturers of this new product. The cause & effect chain is the elements cause the generation & control of more energy than is possible for the user causing the addition of healthy human cells of connective tissue, with increased metabolic ability, connecting other brain cells, with increased metabolic ability, that accelerates the increase in ability. Nutritional supplements will play a key role in realizing optimum results from this system.

This system will improve the quality of life for everyone including the super rich vying for more power even though the increase in power does not improve the quality of their life; the knowledge in the 1^{st} element articulates this truth. The message in the 1^{st} element will be personalized to each identifiable group of each society here on planet earth; each group will then be a source of revenue for manufacturers of this system. As this technology spreads around the globe significantly increasing mental abilities of people everywhere the negative consequences of ignorance will be reduced, and eventually eliminated. Every culture's ineffective ways of living will adapt to more effective ways due to increased mental ability.

Ignorance in humanity is expressed in ways that is comprehensively captured in the seven sins. The basic moral message of Religions & spiritual disciplines supercharged with technology accelerating our conscious ability to live wisely and evolve abilities not yet realized is the path of our evolution.

The seven sins are:
1. Gluttony
2. Lust
3. Greed
4. Sloth
5. Envy
6. Wrath
7. Pride

When the human race's minimum level of mental ability to understand & adapt to life is increased around the world these primitive expressions will be eliminated from our DNA. This will be a magnificent step in our evolution. All of these primitive awkward expressions are due to the ignorance of a better option being available to think, feel, act and practice into habit. The seven sin or foolish imbalances are primitive states of consciousness that lower the quality of life for the one expressing the states and those around them experiencing the expression. Using technology we can accelerate teaching the core truths that determine a person's health & happiness, just the core truths, no peripheral information about the truth, just the truths directly applied to how one avoids pain and creates pleasure in functional ways to live & enjoy a life of abundance. Then computer generated images will do something amazing, it will provide the person with the details of the thoughts they wish to think so they can imitate it accelerating their thinking the details of the thought. Imitating our parents, siblings & friends is how we learn life skills faster. But copying someone's thoughts is more elusive, especially when our confidence is damaged from someone critiquing us in a way that stops us from using trial & error effectively. Turning thoughts into visible phenomena for people to then copy or compare with their own inner field of conscious energy will enable humanity to overcome getting stuck in struggle rather than see the details of the thoughts to discover what is causing the struggle and then adapt effectively. This is what technology can & will do!

This education and supercharged practice sessions continued throughout the days of our life will accelerate our rising above these primitive states and their negative consequences. This system is potentially one of the greatest systems ever! Yes I am a salesman and I believe in this system. Time will tell its impact on humanity. For now let's kick the butt of ignorance strengthening people's nervous system everywhere to improve the quality of life for them and everyone they encounter.

To realize the ideal outcome of this new product we will strive to account for every aspect of human conscious ability stored in the cellular knowledge and beyond. If we leave one out or don't add it to the process in the most effective way possible there will be more refinement to be done by creative men and woman improving future models of this system. We will quantify every aspect of human ability and the personality traits that limit optimum ability and introduce specific elements at the precise time in perfect proportion and duration to strengthen weakness & create skill where it's lacking in the most powerfully effective way possible to accelerate them realizing their highest abilities possible.

Energy Charts of Ability—The evolution of this technology in the comings years and decades will improve the accuracy of the instruments that measure & identify the field of conscious energy and the energy movement in the nervous system for fundamental & specific abilities people desire to learn. These recordings will become “Energy Charts of Ability” that establish “the critical mass of energy & it's precise movement” for an expanding list of abilities; whether it be completing mathematical calculations or listening intentively to a person talking or career or trade skills and incredible mental tasks completed by historic men & woman i.e. (imagine traveling on a beam of light, which I believe will become one of the fundamental mental abilities for all people to practice to realize their highest mental abilities).

These Energy Charts of Ability will establish targets for users to emulate, imitate & expand in their practice. They will not be intended to replace the user developing sensory acuity to the energy movement within as this internal knowledge is part of realizing one's highest mental abilities; that said these charts will capture and present the field of conscious ability to read like a musical chart displays the interplay of melody and harmony these charts will capture the beautiful rise and fall of vibrations of the field of conscious energy identifying pivotal points in the ability where a little more energy held stable here, or little less energy there to more precisely execute an ability. These charts will make the invisible world of thought visible in a profound way to benefit humanity.

The profound benefit to us, the human race, will be when technology allows every person to realize their highest abilities. Certainly the socioeconomic realities of our world pose significant obstacles to this historic undertaking but look what technology has done so far; it brought us out of caves and into the 21 century powered with incredible technology. The best thing technology can do is accelerate our ability to realize more of our potential, so that we, the human race become an incredibly more capable & wise race of being that is liberated from suffering & pain from finding and nurturing the balance between competing & cooperating to realize levels imagined by few.

When any person realizes their highest abilities it strengthens the very core of who they are. This core is where the spirit of the person exists; it is made of energy just as the desires, thoughts, emotions & behaviors expressed from it are. Strengthening this core to a fundamentally healthy level is what causes the person to see opportunities to release from the negative consequences of ignorance to embrace the positive benefits of awareness & ultimately wisdom. Wisdom chooses the most beneficial option available in each moment to create the best life possible. Making this logical choice is based in an understanding of life derived from synergizing spirituality with the sciences that clearly identifies the need to create the habits of fulfilling both the needs & desires of one's life as effectively as possible by mindfully choosing to flow the most powerful thought or emotion available in any circumstance; that being appreciation or love. This universal truth will be discovered and benefited from any user of this model of this new product from the teachings in the first element. These teachings are subject to interpretation, the manufacturer of another model could choose another set of principles to educate the user to understand human consciousness to heighten sensory acuity, or the system could work without the first element, just not as effectively.

The basic outline of the teaching of the first element to enable the user to fully embrace the elements of the preferred embodiment of the invention is found within this patent including:

Examining the presence of energy in any form of life we discover it cycles over and over throughout its life; the energy within the life form interacts with the energy outside, within the constraints of time and space, to develop the ability to survive & thrive, and, for people, determine the quality of life.

It is the:
The cycles of energy moving in the biology of a person (interacting with)
The cycles of energy of time & space outside (that develops)
The human cell tissues inside (that generates)
The amount of energy present &
The control of its movement

That determines the abilities of a person and the quality of their life.

To enhance the capabilities of a person's biology he or she engages in the process of generating and controlling the energy of the activity they seek improvement at in “an environment appropriate for those movements to occur.” The actual generating & controlling of the energy inside the person's brain is what causes new cells to be created to form the muscles of connective tissue connecting other areas of the brain to participate in generating more energy & controlling it in that ability. This technology enhances the learning process by A) synergizing multiple elements that nurture & intensify the person generating and controlling more energy and B) excluding elements that distract or interfere.

The increase of energy generated in practice sessions “generates momentum in a growth cycle,” when the new cells of connective tissue creates a connective branch connecting a critical mass number of cells to join into the single activity of generating & controlling conscious energy. The evolution of this system will create growth charts illustrating predictable growth of the branches based on:
Time practiced, both practice sessions & in flow of life
Average level of intensity, both practice session & in flow of life
Effective execution of content to build habit of ability & belief
Nutritional support and rest.

Predictable generation of tissue will create the predictable increase in habits of ability & belief.

The specific purpose of the system is to “optimize the space & use of time” in the field of conscious energy from a perfect blend of synergized elements to “stimulate the user at predictable times & places in the content when the untrained mind looses intensity & control of energy flow.” This is what causes the user to generate & control levels of (Intensity & Clarity of Thought & Emotion for More Time) in their practice that is beyond their current ability to realize the critical mass of content of energy necessary to cause it to cycle in the consciousness for hours after as well as program the nervous system to naturally flow the thoughts & emotions to be the person to create the life they desire.

The 6 elements of the system are:

1. Education & Training—To prepare the user to fully engage the system they are educated on the predictable cycles of human consciousness and life that illustrates how human ability is realized that in turn explains how the system accelerates increasing ability & programming desired habits. And they are trained how to most effectively engage the practice and how to most effectively execute thoughts & emotions of the practice to use in their life.

2. Engaging “the process” of identifying & releasing from habits of ignoring life and neglecting their abilities and thus struggle at life to engage the habit of observing life and nurturing their abilities and thus adapt to life.

3. A library of computer generated images of “human abilities” illustrating the relevant details of the content of thought & emotion, functioning at high performance levels, for the user to emulate & imitate to rediscover the joy of expressing it with a playful creative spirit to expand it. Computer generated images will make the details of conscious ability visible for people to imitate to breakthrough invisible barriers & realize untapped ability.

4. A “super charged learning habitat of synergized elements” that cause the user to generate & control levels of (Intensity & Clarity of Thought & Emotion 4 More Time) that are beyond their ability without the presence of the elements. This is the first half of practice to create maximum acceleration of increase of ability & programming of desired habits & beliefs.

5. A mobile devise to trigger & remind the user to continue practicing silencing negative or mindless self talk to engage high performance consciousness and to imagine and or feel a set of “formulated stories of the desired content of life experience” throughout the day that constructs the necessary details of the desired habits of ability & belief exponentially increasing practice time. This is the second half of practice to create maximum acceleration of increase of ability & programming desired habits of belief.

6. A Planning, Monitoring & Scheduling module that guides the user fully engage & balance all of the elements of the system to optimize accelerating their growth of ability & programming of desired habits & beliefs.

Prior to feedback from the system in use an example of organizing the 6 elements and more information of them is:

1. The 1^{st} activity to accelerate a user generating increased levels of conscious energy with greater control is an education in human consciousness; understanding what creates it and the nature & tendencies of it moving about inside of the user is what facilitates them embracing the other elements of the technology more effectively. Computer generated imagery will play a key role in this element of education as it will in the key element of the system of supplying the details of the content of thought & emotion to emulate & imitate causing an instant increase in generation & control of more energy to ultimately creatively expand it. Making the invisible field of conscious energy visible to the user will facilitate them developing sensory awareness of the details of its presence accelerating an increase in ability to generate more of it and control it in their practice. The science lessons in Physics, Psychology & Biology to understand the nature of human consciousness moving in cycles inside of them will lack any credits or history of, rather, only show how the laws of Physics illustrate the interdependent cause & effect realities of Psychology & Biology that determine the amount of energy a person generates & controls in adapting to their life in the socioeconomic environments of earth. This information will demystify the mysteries of what the person is thinking, feeling & are able to do each moment of their life. The profound & self evident truths of Classical Physics empowered with the magical laws of Quantum Physics gives the user an understanding of the purpose & potential of human consciousness. Its purpose to fulfill the needs and desires of a social & biological living organism; its potential far exceeds what is necessary to do this. Developing it potential beyond these responsibilities to realize higher levels of human ability is the pathway of our evolution.

Fundamentally the energy of life shines like stars. The shine of human consciousness is evolving through the lower levels of the weakened mental ability caused from ignoring the relevant realities of life to the brightness of increased mental ability from rigorously processing the realities of life and exploring the expanse of the universe with the imagination.

Best effort—for any person to realize their highest abilities with this technology or without it they must practice giving their best effort of performance when appropriate in whatever they are thinking, feeling or doing. Due to ignorance in the vast majority of homes around the world, parents awkwardly criticize their children dousing the fire of their desire to give their best effort to shine. Shining to shine because it's possible to shine and it is better to shine than not is a fundamental truth for humanity to embrace. The computer generated imagery defining the key elements of conscious ability will illustrate the effect of giving best effort has on optimizing the generation of new connective tissue that generates & controls the increased energy of increased ability. The increased density of connective tissue increases the ability to bring more intensity of effort while sustaining a relaxed mastery of control. This maximum effort is likened to a trained athlete pushing themselves down the final stretch of a race when the untrained mind would pull up because it is not accustomed to the intensity of strain or the physical discomfort of sustaining it. It is the practice of pushing oneself to new levels of focused effort is one of the keys to realizing new levels of ability. This premise is one of the keys to accelerating humanity realizing new abilities not yet realized.

Desire & Determination—another key for a person to realize their highest abilities is the presence of desire or determination within. When a person generates increased levels of energy of thought & positive emotion to the things they desire in their life with the intention of increasing the size of the desire increases the mass of the desire in the nervous system; best effort in this intention of attention realizes optimum growth for the user. When the density of the connective tissue generated from a person expressing desire & determination reaches a critical mass all of energy of conscious & subconscious thoughts & emotions are constantly influenced from its presence. This internal source is likened to a star in space; its gravitational power impacts everything in it vicinity. The system will accelerate the user realizing this critical mass of tissue of “functional desire” creating a consistent flow of purposeful thoughts, emotions & behavior to be the person they need to be to create the life they desire.

Caring vs. indifference—another key this model will teach is the key of caring for a functional balance of need & desire to increase the user's ability to generate & control energy. Effectively caring for the needs & desires of a shining social & biological living organism is the direct path to generating & controlling more energy; it is the fundamental message of this prototype. It is the direct path to live the best life possible for every person alive.

To identify thought & emotion as phenomenon separate from and happening to the self functioning to fulfill its needs and desires we find.

In exact accordance to the laws of Physics the energy of every thought & emotion of life “cycles in predictable patterns” and is either:
Positive, Neutral or Negative that is either
Functioning to attend to and fulfill need & desire or
Dysfunctioning to ignore & neglect them.

Every need or desire ignored and neglected distracts & weakens the field of conscious energy to lower the quality of life.

Every need or desire attended to & fulfilled unites & strengthens the field of conscious energy to increase the quality of life.

All needs are absolute and must be attended to avoid the negative consequences that will be equal to the importance of the need and how long it is neglected.

All desires are not absolute and are either:
Functional to align with fulfilling needs & other desires or Dysfunctional causing a person to ignore & neglect needs & other desires.
Dysfunctional desires can be washed out of the cells of the nervous system with the energy of functional desires.
To fulfill any need or desire requires a person to “complete a task” causing something to happen.

Ability is required to complete the tasks of life.

All ability requires a critical mass of energy generated & controlled.

The amount of energy generated & controlled is determined by the amount of energy necessary to complete the task.

Pleasure is a flow of energy in the senses of the body perceiving a need or desire being fulfilled; it is a flow of energy in the body.

This flow of positive energy can be simulated by connecting conscious attention to the flow of breath as a tool to direct energy on a purposeful path of completing a task and sensing it.

When the energy of applying these principles to the user's habits reaches a critical mass of cycled energy the habits of the new connective tissue cells and the areas of the brain connected to work together will perpetually flow the energy of awareness of the purpose of & level of potential realized of their habits of ability to fulfill need & desire. The presence of this light of consciousness shining on the realities of their life is the same light that will liberate them from the negative consequences of a lazy consciousness foolishly ignoring and thus unable to be aware and adapt to the relevant realities of their needs & desires.

Everything the energy of consciousness does relative to fulfilling need and desire is effectively identified as ability.

Conscious ability, the foundation of all ability, is a product of
1) Levels of and control of energy in the nervous system generated from
2) A critical mass of (branches of cells of connective tissue) developed from
3) A critical mass of energy generated & controlled for cycles or repetitions of time nurtured from
4) A critical mass of cycles of nutrition & rest Computer generated images illustrating & simplifying the predictable cycles within the field of conscious energy illuminates the opportunity for any person to develop their conscious ability and how this new technology synergizes multiple elements together to speed up the process and makes it a pleasing experience to engage. Shoot, sign me up.

These computer generated images illustrate the simple purpose & potential of the consciousness inside the user for them to understand how the vehicle of consciousness experiences life, and, how they will live the best life possible for them when they optimize the presence of positive thoughts & emotions that function to fulfill a balance of need and desire in their life. This simple truth leads one to realize that practicing sound moral principles is a reliable path to follow to keep heading in the direction to realize this ultimate accomplishment. I believe, like many others do there is a single light of truth; I believe this prototype will effectively articulate this beautiful & profound truth to the human nervous systems to shine a light in the dark corners of the weakened primitive states of ignorance to cause, in many instances, an immediate emergence of Wisdom, the ultimate state of understanding. We will hire talented writers to deliver these profound truths in the most entertaining ways we can, adapted to each personality type or set of life experiences as quickly as possible. The content from this 1^{st} element poises the user to embrace the 2^{nd} element of the technology.

2. The 2^{nd} activity to accelerate a user realizing higher levels of ability is to apply the information from the 1^{st} element to the 2^{nd} element to engage “the process” of analyzing their habits of thought, emotion & behavior relative to fulfilling need and desire. Improving the quality of life is realized from developing more of the human potential that lies dormant within. This is most efficiently done through the process of generating and controlling increased levels of energy to program increased levels of ability and functional habits & beliefs. It is all about the level of energy consistently generated masterfully skilled to fulfill need and desire. The 2^{nd} element is the process of observing & sensing this to identify what is happening and if it's happening as well as possible. Increased energy flow in the nervous system free from distraction creates awareness and intuition working together to optimize discovering opportunities to improve the self to improve your life.

The insights from the 1^{st} element applied to their habits of thought & emotion expressed as behavior causes them to see how much energy they are generating & controlling that is determining their ability to do everything. The curriculum of this technology will consistently & relentlessly direct their intellect to identify if they are generating & controlling enough energy to adapt to their life to fulfill their needs & desires. The user is taught whatever their abilities are in their life they are a product of their life to this point and very importantly they can improve them, often significantly in a matter of days or weeks, when they engage the technology to the best of their ability.

The ultimate challenge—The user engages this initial round of “the process” informed of the ultimate challenge of identifying the never ending stream of conscious thought, which to most people is camouflaged as reality. This ultimate challenge illuminates the need and benefit of the tools of Calculus, without the math. Computer generated images will clearly identify the need for the user to engage the power of the integral within their field of conscious energy to quiet the chatter of mindless self talk that interferes with them focusing their attention contemplatively and repeatedly enough to verify the interpretations of their thoughts, emotions and behavior are accurate. All of the relevant truths found from blending the three core sciences of Physics, Psychology & Biology will relentlessly be pointed to make the key distinction that accurate knowledge is required to adapt higher levels of ability instead of struggle. This key point illuminates the reality that wherever there is pain in their life applying vigilance inward to effectively apply the power of the integral to identify the beliefs that are limiting their ability to adapt so they can use the product to accelerate programming the habits of thought, emotion & behavior to liberate them ignoring life that leads to the pain & struggle of ignorance. The derivative empowers the user to quickly see tomorrow's pain caused from today's dysfunctional habits as a source of motivation to change those habits to improve their life. The integral & derivative effectively executed in a user's field of conscious energy will create the accurate knowledge about their habits of thought & emotion to identify where their abilities to adapt are limited and the use of technology to accelerate generating the habits of abilities and belief to fulfill need and desire. This initial round of self analysis poises the user to engage the 3^{rd} element.

3. The 3^{rd} activity is another round of education & training that will again rely on computer generated imagery to make visible the invisible world of thought & emotion. This time the energy of mindfulness techniques will be presented for the user to imitate to accelerate executing them effectively. The skill of observing and identifying thought & emotion in the flow of life accurately as a phenomena rather than misidentifying them as them self is a pivotal distinction in realizing one's highest abilities. Never realized by most people, this single thought process is the only way a person can personally liberate them self from struggle and refine the skills of generating & controlling conscious energy to realize high performance levels, which is the pathway of our evolution.

The mindfulness techniques are precise postures and movements of part of the conscious energy observing or sensing the rest of the field of conscious energy to access how this internal phenomenon is performing at completing the task at hand. When this skill is practiced and effectively applied to all the task of the user's life they will have realized mastery over their life to the degree they have used it to develop habits of ability to avoid struggle, to complete the tasks of their life effectively & efficiently and adapt masterfully to new challenges of their life. Any person who has completed this internal work will have all their needs fulfilled on time and carefully programmed functional desires in and dysfunctional desires out of the flow of their consciousness. There will be a set of charts of ability that address this mastery of life. These ancient techniques will be understood and enhanced with the precise knowledge of the sciences adding the perspective of looking within their (Biology), knowing it is the capacity of the synaptic firing of their brain cells that is generating & controlling the energy of the abilities of the thoughts & emotions of their consciousness, the (Psychology). The techniques of mindfulness involve the three simple steps of:
1) Identifying negative & mindless thoughts & emotions that limit ability
2) Releasing from them
3) Embracing positive & purposeful ones, developing higher levels of ability.

Realizing one's highest abilities to enjoy the best life possible requires these three steps. Using the technology to generate cycles of (Intensity & Clarity of Thought & Emotion 4 Enough Time) at taking the three steps accelerates creating the habit. This habit of conscious being is how one realizes the awareness of & the sensory acuity to the details of their own inner world of thought & emotion to discover the illusive balance of intensity & relaxation necessary to execute the quintessential skill of imagination with higher levels of power & control. Imagining the cause & effect phenomena of life is the power center skill of human consciousness.

In the charts of ability taking these three steps is a fundamental one to complete generating the critical mass of energy exerted & controlled to stabilize the field of conscious energy to set the foundation for all other abilities. The mindfulness techniques poise the user to engage the 4^{th} element.

4. The 4th activity is another round of the 1^{st} element of training, this time in the first of three modalities of thought that make up “the content of thought & emotion” the user will emulate & imitate to generate higher levels of conscious energy with greater control to then playfully and creatively expand to realize the highest levels of conscious experience and ability. Symbols, Imagination & Emotion and Positive Language are the modalities. It is the opinion of the inventor that these three modalities of thought are fundamental to all thought processes, but hey, he's a Realtor so he could be wrong, he he. These initial modalities and other(s) discovered as the technology develops will become additional elements that contribute further to the premise of the system of using technology to synergize multiple elements into a sensory experience to cause a user to generate levels of conscious energy with greater control beyond their current ability creating the acceleration in increasing ability and programming desires habits & beliefs of the system.

Symbolizing is the 1^{st} Modality taught. Symbols represent the macro state of consciousness. The macro state is the size, power & coordination of the field of conscious energy that determines it abilities to impact whatever environment it is in, and, others it is not in via Quantum law. Without this system the stability & ability of a high performance macro state develops in a person from the accumulative life experiences causing them to complete a critical mass of energy of ability over time with the elements of nutrition & rest to generate the connective tissue of mental muscles. For the vast majority of people this critical mass of life experiences never happen, to the contrary, they also experience a critical mass of criticism creating limiting beliefs & expectation in their ability that causes them to unconsciously use only part of the cells of the brain to generate & control energy in addition to not developing the connective tissue. This is where we are in our evolution. This system offers people an opportunity to quickly reverse the effects of a dysfunctional childhood and feel good in the process. Once again computer generated images will illustrate the relevant aspects of the high performance conscious state visible for the user to more readily emulate. When any person effectively emulates a field of conscious energy that is larger, flowing more energy, that is coordinated and void of distraction, in the majority of cases it will instantly give the user a significant increase of energy to access to imitate & expand the micro details of the desired content more effectively within their field of conscious energy.

The symbols, whether they be a) single words b) short phrases or c) objects they represent “Desired Conscious Realities Realized.” To effectively emulate a “desired reality being realized” the user must give their best effort at “pretending” with every ounce of their essence the desired high performance state exists within them right now in this moment, yes we all need to take up acting, he he. These desired macro states of consciousness capable of high performance will be:
A) Clear of mindless or negative energy of thought or emotion that distract the person's conscious & subconscious attention & intention to process more data and execute skill more effectively;
B) Unite & engage more of the cells from both side of the brain, in many instances instantly increasing the size, power & ability of the field of conscious energy exponentially***;
C) Engage high performance attributes of increased energy of consciousness that causes the person to perform up to their highest abilities of processing more data and executing skill more effectively.

If we analogize increased movement of thought energy caused from this modality with the movement of a human body we would say that for most people engaging & coordinating their full brain into a single positive purpose is likened to a person that has been sitting and only using one arm at a time all of the sudden discovering he or she could stand up, walk, run and jump and use both arms together; the increase in thought & emotion energy moved and controlled is instantly enhanced from emulating full brain engagement.

This modality causes the user to apply what they learned in the first element of looking at the field of conscious energy within their head as the place where the details of their thoughts & emotions are expressing the “beliefs & expectations” that have been created from their life experiences. This basic cause & effect chain of developing ability that a person believes in and expects results from is a core part of the understanding of wisdom. This ability & growth charts of this system will eventually quantify the amount of energy flow required to identify all of their beliefs and expectations, previously oblivious to them. This prototype will lead the user to develop the habit of using mindfulness to identify beliefs & expectations of the macro state that are interpreted from the micro details of the thoughts & emotions being expressed in the flow of life to accelerate liberating themselves from struggle and developing higher levels of ability in their practice and flow of life.

***The instances that will have a user realize an instant exponential increase in size, power & ability will be those people whose energy was oppressed from a critical mass of ridicule and critical treatment in the developmental years. The biological tissues of these people have habits of not participating in generating & controlling energy. When these areas of millions of cells, previously idle or even disrupting the coordination of the other cells, begin to participate in the efforts of the person exponential increases are instantly realized.

5. The 5^{th} activity is another round the 2^{nd} element of “the process” of analyzing their thoughts, emotions & behavior immediately subsequent to each round of training and when insights are discovered or being discovered after practice as well. This modality of training creates detailed knowledge & perspective on how beliefs & expectations play a decisive role in either limiting or liberating them to creatively generate the thoughts, emotions & behavior to adapt instead of struggle. All of the training in this prototype will relentlessly get the user to make the distinction of when fact is scientific fact or when it extends into theory or opinion all of which is used to empower them to accurately identify and master the inner world of thought & emotion to empower them to realize more of their abilities to create a life in the outer world they desire.

There is a critical mass of light of energy that sees reality correctly that will break through the dysfunctional connective tissue of the brain formed from negative life experiences that has been blocking or limiting the user from moving the energy of thought to complete the thought experiments to see the truth and then act and speak effectively to adapt. The user will take a significant step in being liberated from ignorant struggle once the critical mass of conscious energy processes the cause & effect chain of events of their life to personally see clearly how their life experiences have caused their beliefs & expectations to be imprinted in the nervous system that is causing the flow of conscious thought & emotion that is causing their behavior that is contributing to continue whatever realities are in their life. This realization sees the opportunity to move enough energy of thought & emotion in practice or programming to change their beliefs & expectations to change their flow of conscious thought & emotion to change their behavior to change the realities of their life.

The elements of the system guide the user to synergize:
1) Precise vocabulary of knowledge efficiently & effectively interpreting the internal consciousness of thought & emotion relative to fulfilling need & desire to optimize adapting+
2) Finding and increasing the mass and force of their desire to be liberated from pain or create pleasure or both simultaneously that functions to add to tomorrow's health & happiness+
3) Execute mental techniques to accurately imitate the desired content of thought & emotion imprinting new beliefs & expectations in their brain cells increasing the density of the mental muscles of connective tissue to execute increased ability and flow new habits of thought & emotion+

To accelerate breaking through the limitations of primitive states of consciousness, low in energy flow, caused from primitive life experiences.

6. The 6^{th} activity is for the user to access the 3^{rd} element a Library of Symbols that represents desired states of consciousness to load into practice module to practice-program. After the training & self analysis of their habits of thought in this modality the user will have increased ability to identify the symbols most appropriate to their needs, where they struggle to focus their practice. The libraries, in each modality, will be organized in categories of fundamental to all, beginning, intermediate and high levels of ability and as antidotal to common dysfunctional states of the day customized to culture of region.

7. The 7^{th} activity is to engage the 4^{th} element of practice emulating the macro state of high performance by itself; there are basic aspects of both Language & Imagination in the modality. All the elements to this point have educated the user to increase their sensory acuity to the muscles involved with generating and controlling thought & emotion more effectively. Emulating & imitating content is the one element of the technology alone that creates an instant increase in ability. Computer generated imagery of the macro state will give the user a comprehensive illustration of the relevant details of high performance conscious state to emulate. When you want to do anything better in the physical world you find someone who does it exceptionally well with great technique and you imitate their techniques and instantly do it better. The field of conscious energy exists in time and space just like the physical body does; a person with low conscious ability instantly increases their ability by simply imitating the content of a conscious field operating with higher ability. The limitation of what a person can imitate is limited to the supporting biology to generate and control the energy necessary to execute the ability. Emulating the macro states of high performance poises the user to embrace the next element of training on how to generate the micro details of thought & emotion with more ability. When insights are observed and found or being found regularly in reference to habits of not accessing all the resources of desire, effort & techniques another round of the 2^{nd} element is engaged after practice sessions as well.

8. The 8^{th} activity is engaging another round of the 1^{st} element training this time in executing the 2^{nd} Modality of Imagination empowered with Positive Emotion. It is a physical skill of the brain that can be practiced to develop higher ability. The height of the ability continues to rise when the person continues to engage the learning process with a specific intent of realizing higher ability. Einstein said, “Imagination is more important than intelligence.” Mark Miller humbly adds, “Imagination is “the Tool” of intelligence and the Swiss knife of human consciousness.” A) Imagination completes the thought experiments by accurately representing any and all cause & effect experiences of life and the causal experiences leading up to it for the person to gain knowledge and understand what really happened and why. The ability of imagination to gain knowledge is limited to the ability of the person to generate the field of conscious energy and control it enough to accurately re-create the details of the phenomena of reality repeatedly and precisely to be able to effectively apply the integral to verify their knowledge of it is accurate and complete. B) Imagination+positive emotion is the process a user engages to program their nervous system with the habits of belief & ability they desire. There is a critical mass of Positive emotion existing in a human nervous system that heals diseased cells damaged from negative emotions, chronic stress and even toxic substances as long as the dose of it is not too excessive. This system will enable a user to generate significantly higher doses of positive emotion than are possible without the system. The user will logically program in the healthy habits of fulfilling their needs & desires, including nutrition, exercise, rest as well as contributing to their personal & financial relationships to create the physical realities of life to logically support and sustain the positive emotions.

Imagination is directed to realize productive results from concisely expressed Language; too many words consume resources and distract the conscious energy from generating & controlling images. In the Practice Module concise language will direct the expansion of the content of thought & emotion that is generated from imitating the images of desired content. This prototype will access the best available training from the best trainers and their material available in each of the modalities to empower the user to realize their highest abilities. The competition to deliver the best results from different manufacturers of this new product will be a positive force in propelling our evolution into an exciting future.

9. The 9^{th} activity is another round of the 2^{nd} element of “the process” of analyzing their own habits of ability of thoughts & emotions this time focusing on their use of imagination & emotion, each round increases their sensory acuity to increase skill and potentially, will uncover aspects of habits of ability or limitation of ability not yet realized to progress in the journey of developing their highest abilities. The user's quest for detailed knowledge of this ability to improve their life will know its effectiveness is dependent on the belief & expectation of the first modality creating a field of conscious energy that is large & stable with power, clarity & confidence to imagine more information effectively.

10. The 10^{th} activity is for the user to access the 3^{rd} element of a library of “sets of images” of content of sensory rich details of desired realities they wish to realize, or of information they wish to memorize to become working knowledge. Instead of computer generated images creating environments for a video player to race cars, kill opponents or chase a widget the content will be organized to present a set of:
1) Desired outcomes realized empowered with positive emotion plus
2) The arduous activities necessary to create it empowered with appreciation of the self for being the disciplined person realizing their desires.

The sets of images will supply the user with a critical mass of sensory details of the outcomes they wish to realize and the habits of belief, ability & behavior necessary to create it. To realize this new reality in their life the user will meticulously complete the critical mass of time programming the necessary details of each habit of ability, belief, behavior & emotion into their nervous system to create the new flow of conscious energy within them to cause them to be the person who will create what they desire in their life. Without these sets of images the average person will not complete the critical mass of energy flow to the necessary details of required content to program in the new information needed to become the person to create what they desire. These sets of images will have a logical and usable connection to the Charts of Ability. Understanding both will empower the user with increased knowledge & sensory acuity to fully embrace the elements of the system to accelerate realizing higher abilities.

11. The 11^{th} activity is to engage the 4^{th} element imitating the content of images & emotions with their best effort. This second stage of the practice synergizes the presentation of elements of content of:
1) The macro state executing
2) The micro details of thought & emotion
3) With technique tips to do it with precision.

Executing all three elements into their field of conscious energy is required to optimize acceleration of increase of ability and programming of desired habits & belief. It is the presence of the elements that causes the user to generate “the high performance field of conscious energy” that contains more of the relevant details of the content sustained for more time and that is void of any foreign content for any time i.e. the causal forces of limiting belief or incongruent intent or desire causing any resources of brain tissue to not unite together effectively to execute the content with maximum energy and control. All of the elements leading up to this one increases the user's ability to emulate, imitate & expand the content with increased (Intensity & Clarity of Thought & Emotion 4 More Time) to optimize acceleration of increase of ability and programming desired habits.

12. The 12^{th} activity is another round of the 1^{st} element in the training in the 3^{rd} and final Modality of Linguistic that directs and interacts with the other two modalities of Imagination & Emotion and the Symbols to give the user a comprehensive understanding and skill set to master human consciousness. It is certainly possible that the use of the system or new product will prove a different order of the modalities is taught, however the first two modalities will have the very basics of language taught to facilitate executing them. There will be basic grammar or sentence structure taught to facilitate the user expressing the thoughts in variety of ways to keep the programming fresh over time. Used effectively language:
1) Expresses the mantras as a symbol to engage high performance states of consciousness in practice and in the flow of life
2) Keeps the images and emotions moving efficiently on a desired path to program the self with improved habits of belief & ability
3) Directs the images to effectively apply the integral & derivative to process cause and effect realities of life to optimize adapting

The linguistic training creates the skills to communicate effectively with them self that directly applies to communicating effectively with others. Additional training on communicating will enhance the user's ability in their human relationships.

13. The 13^{th} is yes, another round of the 2^{nd} element of “the process” of identifying the self talk that fills their days. Self talk is verbalization of hidden beliefs and the director of imagination & emotion misperceived as reality. When the light of user's consciousness has processed the macro chart of conscious ability and applied it to their life they will begin to naturally identify all of their thoughts & emotions to be Positive, Neutral or Negative that either functions at fulfilling need and desire or dysfunctions to ignore and neglect them.

14. The 14^{th} activity is engaging the 3^{rd} element of a Library of language. The “sets of statements or beliefs” will be organized to construct a self esteem that shines as well as optimizing increasing ability & programming habit. The “sets of statements” will fit together to direct and interact with the “sets of images & emotions” both synergized in the presentation with the technique tips to keep the user fundamentally sound in their execution while giving best effort and expecting great results. The presence of the elements is what causes the user to generate the (Intensity & Clarity of Thought & Emotion 4 More Time) beyond their current ability. Executing all of the elements is necessary to maximize acceleration of increase of ability and programming habit.

15. The 15^{th} activity is to engage the 4^{th} element of imitating the content of the language directing and interacting with images & emotions. This third stage of the practice synergizes the presentation of elements of content of:
1) The macro state executing
2) The micro details of language directing & interacting with the thought & emotion
3) With technique tips to do it with precision.

Executing all three elements into their field of conscious energy is required to optimize acceleration of increase of ability and programming of desired habits & belief. It is the presence of the elements that causes the user to generate the high performance field of conscious energy that contains more of the relevant details of the content sustained for more time and that is void of any foreign content for any time i.e. the causal forces of limiting belief or incongruent intent or desire causing any resources of brain tissue to not unite together effectively to execute the content with maximum energy and control. All of the elements leading up to this one increases the user's ability to emulate, imitate & expand the content of all three modalities with increased (Intensity & Clarity of Thought & Emotion 4 More Time) to optimize acceleration of increase of ability and programming desired habits. Synergizing the three modalities is the complete practice mode for the user to practice in. It is expected that sharpening each modality separated as needed will improve executing the three as one high performance field of conscious energy. As the sensory acuity develops the user will more readily make the distinction of which mode to practice alone to create optimum flow

16. The 16^{th} activity is to engage the 5^{th} element the mobile devise presents timed stimulus triggers and or reminders to keep the user flowing the desired content to Be the person they desire throughout their day; and allows the user to record challenges to focus practice sessions on. Depending on the intensity of the internal flow of undesired thought & emotion and the external circumstances of the user a variety of Flow Stimulus Programs will be available. The programs will vary in duration, frequency of stimulus triggers, if they are both audio and visual, how much detail is in each, how many ideas or concepts are included and the order they occur.

17. The 17^{th} activity is to engage the 6^{th} element of Planning, Monitoring & Scheduling module. As well as including the best ideas from planning programs available in the market this prototype will integrate the “cycles of growth” in developing the “charts of ability, habit & emotion” to accelerate increasing any habit of ability or belief; it will continue to base the growth on nurturing & managing energy. The color scheme, style of language will also be personalized for different cultures, personality types, age groups and potentially gender.

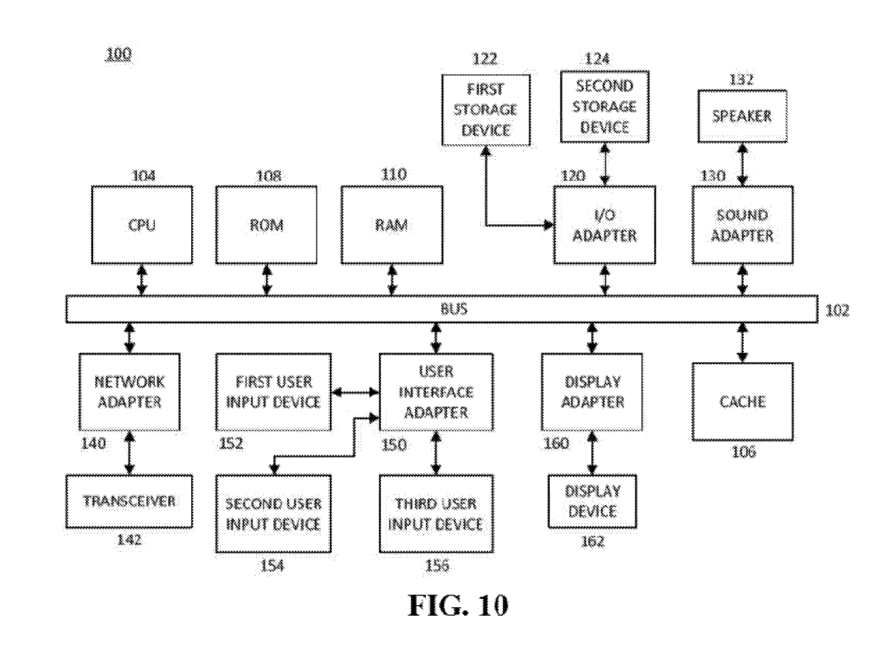

Referring now to the drawings in which like numerals represent the same or similar elements and initially to FIG. 10, an exemplary processing system 100, to which the present principles may be applied, is illustratively depicted in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

Further, it is to be appreciated that processing system 100 may perform at least part of the methods described herein including, for example, at least part of methods of FIGS. 1-9.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A system for self-improvement learning, comprising:
an education and training module to educate a user on predictable cycles of human consciousness and life and to inform the user how to learn as effectively as possible;
a module for identifying and releasing habits of ignoring life and neglecting their abilities, the module training a habit of observing life to nurture user abilities;
a library of computer generated images illustrating high performance thought and emotion for people to load into the practice module to emulate, imitate and expand;
a library of positive language that interacts with the computer generated images synergized together to illustrate high performance thought and emotion for people to load into the practice module to emulate, imitate and expand;
a learning habitat of synergized elements that causes the User to generate & control increased levels of Intensity & Clarity of Thought & Emotion to accelerate learning, improving skill and programming habits;
a practice module on a mobile device to trigger and remind the user to practice imagining and or feeling a “formulated story of the desired content of life experience” throughout the day that constructs the desired habits of ability & belief in the nervous system exponentially increasing practice time;
a Planning, Monitoring and Scheduling module that guides the user to fully engage & balance all of the elements of the system to optimize accelerating their growth of ability & programming of desired habits & beliefs.

2. The system of claim 1, comprising a module for educating on conscious energy, the module including computer generated imagery for thought & emotion, the module synergizing Physics, Psychology & Biology into a single perspective for the user to understand how their consciousness, their biology generating it and the environments they live in move about and interact in predictable patterns.

3. The system of claim 1, comprising a module to develop the habit of analyzing each and every habit of thought, emotion & behavior to refine it into an effective form.

4. The system of claim 1, comprising computer generated imagery to show mental techniques of Mindfulness, observing & identifying the thoughts & emotions of life as the phenomena that it is.

5. The system of claim 1, comprising a module for educating modes of Conscious Ability, wherein the training in each mode forms the content of the element of Technique tips synergized into the practice module that accelerates the user developing sound fundamentals of high performance conscious ability free from any hindering factor, the module further including computer generated images for illustrating details of content of the conscious field of energy and what the biology does in generating the most energy possible with the greatest control.

6. The system of claim 1, wherein after each round of training and when insights are discovered or being discovered after practice as well, the user engages another round of analysis of their habits of ability & belief to increase self knowledge including determining what percentage of potential ability they are accessing, the module helping the user to search, discover and program away limiting beliefs, dysfunctional desires or habits that reduce the health of their biology and the quality of conscious experiences of the user's life.

7. The system of claim 1, comprising a library of Symbols of high performance conscious states to load into the practice module, wherein the symbols comprise fundamental, low, intermediate, high and antidotal to common dysfunctional habits of thought. These sets of Symbols in the future will also fill extensive digital libraries.

8. The system of claim 7, comprising a module for increasing conscious ability is to practice emulating the Symbols to generate the macro state of more energy under more relaxed control that is expecting positive results.

9. The system of claim 1, comprising a module for training in a second mode of conscious ability—Imagination & Positive Emotion, Imagination, the tool to reproduce cause & effect reality of life to think “the thought experiments” to acquire & verify the knowledge of life, and Emotions added to Imagination programs the nervous system with desired habits and heals cells damaged from stress & toxicity with positive energy.

10. The system of claim 1, comprising a self analysis module to increase sensory acuity and discover any limiting beliefs or aspects of their consciousness that is reducing their realizing more ability.

11. The system of claim 1, wherein the user accesses a library of “sets of images” that represent desired outcomes as empowered with positive emotions and activities empowered with appreciation of its benefit, wherein the sets of images addresses internal state of being that causes the person to create the desired external reality. These sets of images & emotions in the future will also fill extensive digital libraries.

12. The system of claim 11, comprising a module prompting the user to imitate the content of the sets of images and emulating a macro state at the same time.

13. The system of claim 1, comprising a module for training in Language, the module providing a tool to communicate with others and direct the Symbols and Imagination & Emotion.

14. The system of claim 1, comprising a module to increase sensory acuity and discover any limiting beliefs or aspects of user consciousness that is reducing user ability.

15. The system of claim 1, comprising a library of “sets of language” that support and interact with the sets of images. These sets of language in the future will also fill extensive digital libraries.

16. The system of claim 1, comprising a module that engages the practice module and synergizes the language with the images with technique tips, the module engaging elements of the practice module causes the content to repeat in the thoughts & emotions for hours after each session.

17. The system of claim 1, a module to organize and present information of any topic of study or skill to accelerate the user memorizing the content and integrating it into their working knowledge and skill to improve their performance of applying that information in their life.

18. The system of claim 1, comprising increasing conscious ability the user has their mobile devise trigger and remind themselves to continue to flow the desired content throughout their day increasing their practice time exponentially.

19. The system of claim 1, comprising a module to monitor, plan & schedule the practice, play, work and rest optimize to user ability, the module accelerating increasing their ability and presence of healthy habits to improve the quality of their life.
